(19) United States
(12) Patent Application Publication
(10) Pub. No.: US 2016/0054518 A1
(43) Pub. Date: Feb. 25, 2016

(54) DISPLAY DEVICE

(71) Applicant: CANON KABUSHIKI KAISHA, Tokyo (JP)

(72) Inventor: Tasuku Uchimi, Chigasaki-shi (JP)

(21) Appl. No.: 14/826,660

(22) Filed: Aug. 14, 2015

(30) Foreign Application Priority Data
Aug. 22, 2014 (JP) 2014-169478

(51) Int. Cl. F21V 8/00; G02F 1/1333

(52) U.S. Cl. CPC G02B 6/0088; G02F 1/133308; G02B 6/005; G02B 6/0031; G02B 6/0073; G02B 6/009

(57) ABSTRACT

A display device is provided, which includes: a display panel; a front surface plate fixed to a display surface of the display panel; a light source disposed on a rear surface side of the display panel; and a frame which accommodates the light source, wherein the front surface plate is larger than the display panel, the frame has a first surface which opposes a peripheral edge portion of the front surface plate that is not fixed to the display surface of the display panel, from the rear surface side, and the front surface plate is fixed to the first surface of the frame.

### BACKGROUND OF THE INVENTION

1. Field of the Invention

The present invention relates to a display device.

2. Description of the Related Art

The basic structure of a display device includes a surface light source device (backlight device), a display panel (liquid crystal panel, etc.), an electric circuit unit, a structural unit supporting these, and an exterior unit. Commercially used display devices include devices having a transparent front surface plate, which is installed on the display surface of the display panel and provides protection from external shocks and/or infiltration of rain water. In order to suppress decline in the visibility of the display image due to the installation of the front surface plate, the display device disclosed in Japanese Patent Application Publication No. 2012-88606 proposes a structure in which a transparent adhesive is disposed in the gap between the display panel and the front surface plate. Furthermore, in the display device disclosed in Japanese Patent Application Publication No. 2012-34289, a structure in which a front surface plate is supported on the housing of the display device is proposed.

FIG. 14 is a diagram showing a principal cross-sectional view of the display device disclosed in Japanese Patent Application Publication No. 2012-34289. On the display surface side of the display device 100, a display panel 103A and a front surface plate 101 are arranged, and the display panel 103A and the front surface plate 101 are bonded by a transparent adhesive (not illustrated). A light source 103C, middle chassis 107, optical sheet 103B and light guide plate 103D are arranged on the opposite side of the display panel 103A to the display surface.

The middle chassis 107 is provided about the periphery of the display panel 103A in order to fix the optical sheet 103B. The light source 103C and the optical sheet 103B, and the light guide plate 103D, are accommodated by a back chassis 108. An installation frame 102 is bonded by double-sided adhesive tape (not illustrated) to the periphery of the front surface plate 101. An installation member 110 for fixing the back chassis 108 and the installation frame 102 is provided. The display panel 103A is held due to the front surface plate 101 being supported by the installation member 110.

### SUMMARY OF THE INVENTION

In the prior art technology disclosed in Japanese Patent Application Publication No. 2012-34289, the installation frame 102 for fixing the front surface plate 101 is positioned to the outside of the backlight unit, which includes the light source 103C, a heat dispersing member 106, the middle chassis 107, and a back chassis 108. Since the components which constitute the backlight unit and the components which fix the front surface plate 101 are separate bodies, then the fixing segment is situated to the outside of the image display region on the display panel 103A, and therefore the frame width W becomes greater. It is desirable for the frame width W to be made smaller, from the viewpoint of the compactification and/or the design properties of the device. Furthermore, since the components constituting the backlight unit and the components used to fix the front surface plate are separate bodies, then the number of components is increased, the structure becomes more complicated, and the cumulative error resulting from the assembly from the front surface plate 101 to the light source 103C becomes greater.

The present invention was devised in view of the abovementioned problems, an object thereof being to provide a display device whereby the frame width of a display device can be reduced by means of a simple structure.

The present invention is a display device, including:

a display panel; a front surface plate fixed to a display surface of the display panel; a light source disposed on a rear surface side of the display panel; and a frame accommodating the light source, wherein the front surface plate is larger than the display panel, the frame has a first surface which opposes, from the rear surface side, a peripheral edge portion of the front surface plate that is not fixed to the display surface of the display panel, and the front surface plate is fixed to the first surface of the frame.

According to the present invention, it is possible to provide a display device in which the frame width of the display device can be reduced, by means of a simple structure.

Further features of the present invention will become apparent from the following description of exemplary embodiments with reference to the attached drawings.

### BRIEF DESCRIPTION OF THE DRAWINGS

FIG. 1 is front surface diagram of a display device according to a first embodiment;

FIG. 2 is an exploded perspective diagram of a display device according to the first embodiment;

FIG. 3 is an exploded perspective diagram of a display panel unit according to the first embodiment;

FIG. 4 is an exploded perspective diagram of a frame unit according to the first embodiment;

FIG. 5 is a cross-sectional diagram along A-A in FIG. 1 of a display device according to the first embodiment;

FIG. 6 is a cross-sectional diagram along B-B in FIG. 1 of a display device according to the first embodiment;

FIG. 7 is front surface diagram of a display device according to a second embodiment;

FIG. 8 is an exploded perspective diagram of a display device according to the second embodiment;

FIG. 9 is a perspective diagram showing the assembly of a chassis and case of the display device according to the second embodiment;

FIG. 10 is a cross-sectional diagram along C-C in FIG. 7 of a display device according to the second embodiment;

FIG. 11 is a cross-sectional diagram along D-D in FIG. 7 of a display device according to the second embodiment;

FIG. 12 is front surface diagram of a display device according to a third embodiment;

FIG. 13 is a cross-sectional diagram along E-E in FIG. 12 of a display device according to the third embodiment; and

FIG. 14 is a principal cross-sectional diagram showing the structure of a conventional display device.

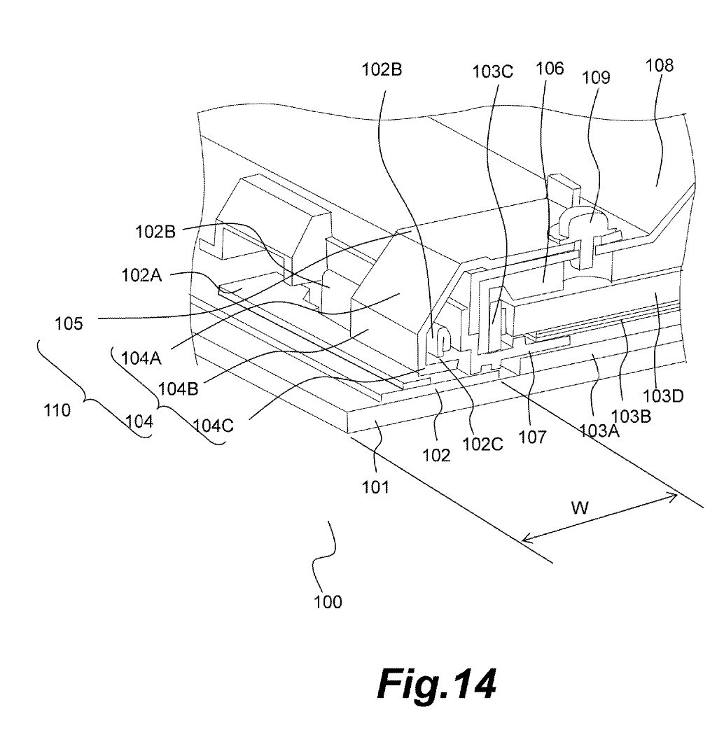

### DESCRIPTION OF THE EMBODIMENTS

### First Embodiment

A first embodiment of a display device according to the present invention is described below.

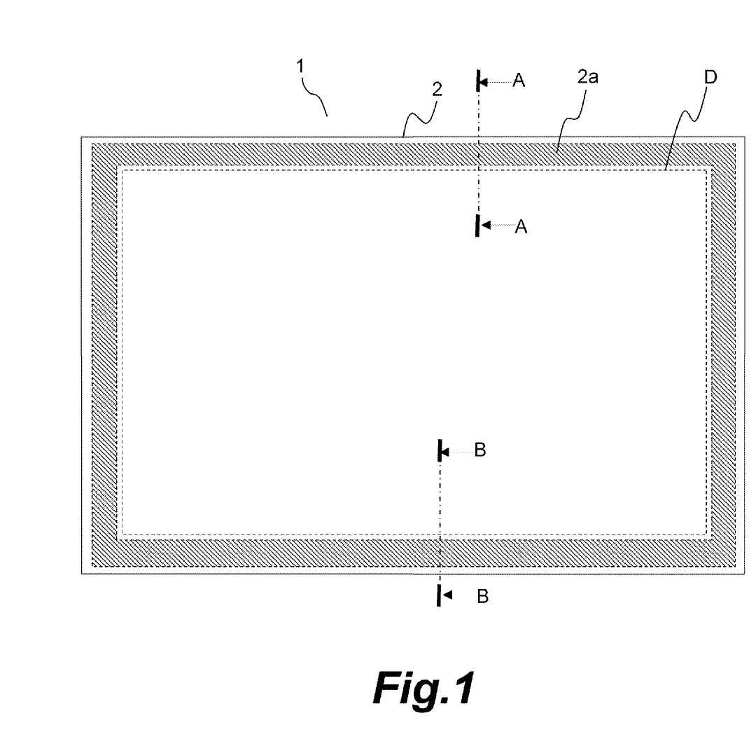

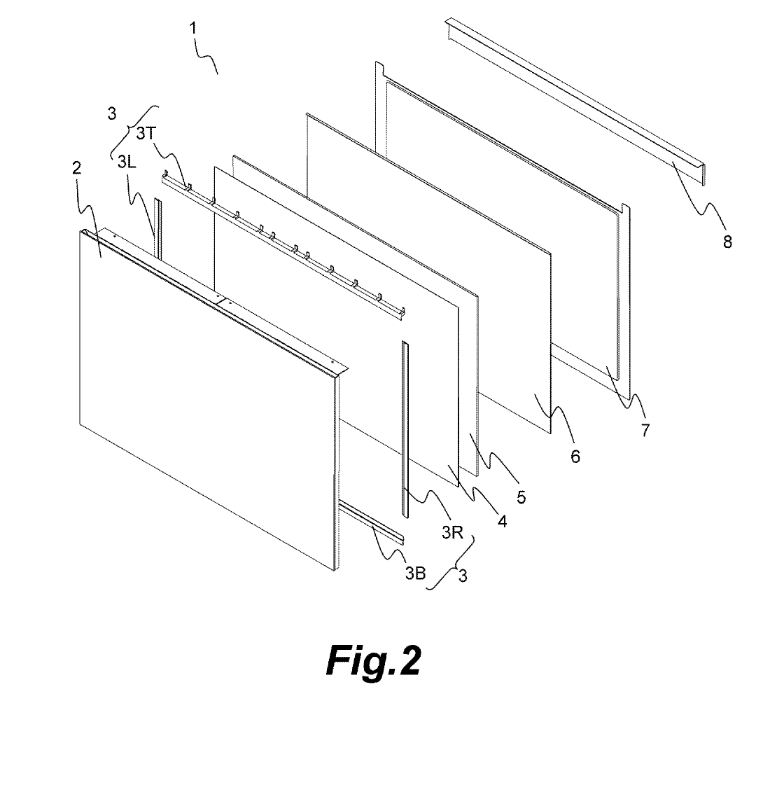

FIG. 1 is front surface diagram of a display device according to a first embodiment of the present invention. Furthermore, FIG. 2 is an exploded perspective diagram of a display device according to the first embodiment of the present invention.

The display device 1 is configured such that the whole of the display panel unit 2 is visible when viewed from the front surface, and there is an image display region D in which an image is displayed, in substantially the central portion of the display panel unit 2. The image display region D is the image display region of the display panel, which is described below. A light shielding printed region 2a is present on the rear surface of the display panel unit 2, to the outside of the image display region D. The display panel unit 2 uses blue sheet glass or strengthened glass as a front surface plate, which is described below, and the front surface plate transmits the image on the display panel which is positioned inside same. An observer is able to observe an image displayed on the liquid crystal panel, via the front surface plate. In the range of the display panel unit 2 positioned to the outside of the image display region D, the front surface plate is made of glass and therefore, by providing the light shielding printed region 2a, the interior thereof is made so as to not be visible. Furthermore, by providing the light shielding printed region 2a, it is possible to impart design properties and improve the external appearance.

The structure of the display device 1 is now described in detail on the basis of FIG. 2. From the front surface side, the display device 1 is constituted by a display panel unit 2, a panel holder 3, an optical sheet 4, a light guide plate 5, a reflection sheet 6, a chassis 7 and a case 8.

A panel holder 3 is disposed on the rear surface side of the display panel unit 2. The panel holder 3 has a frame shape overall, and is configured by a top edge 3T, a left edge 3L, a right edge 3R and a bottom edge 3B. The panel holder 3 is made of resin and the four edges thereof are configured independently. This is because when the dimensions are large, it becomes difficult to form the holder by extrusion molding. Since the optical sheet 4 positioned on the rear surface side is held by the panel holder 3, the distance between the display panel unit 2 and the optical sheet 4 is maintained. The optical sheet 4 is a sheet-shaped component, and the material thereof is polyethylene terephthalate (PET) or polycarbonate (PC), the thickness is several tenths of a mm, and the sheet has flexible properties. The optical sheet 4 is held by the panel holder 3.

The light guide plate 5 and the reflection sheet 6 are disposed on the rear surface side of the optical sheet 4. The chassis 7 which holds these members from the rear surface side is disposed on the rear surface side of the optical sheet 4, the light guide plate 5 and the reflection sheet 6. The chassis 7 is fixed to the display panel unit 2. The upper section of the display device 1 is covered by the case 8.

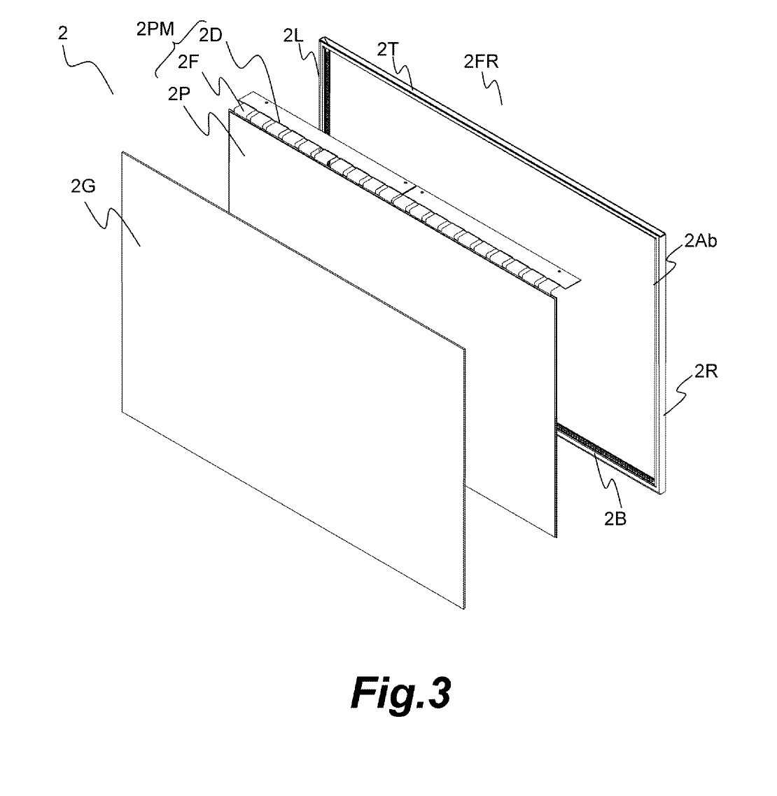

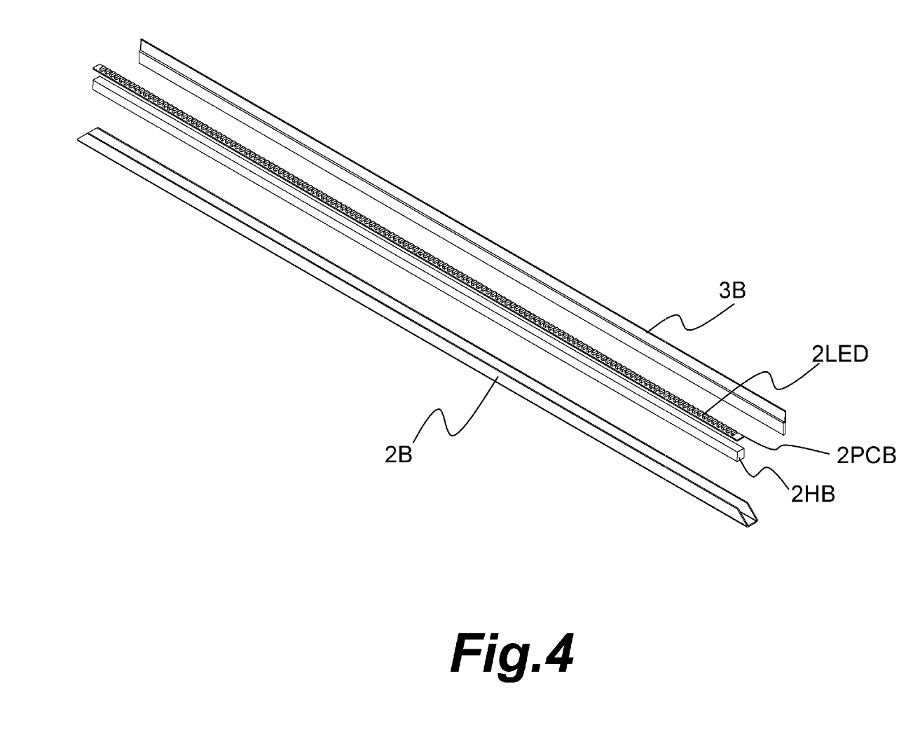

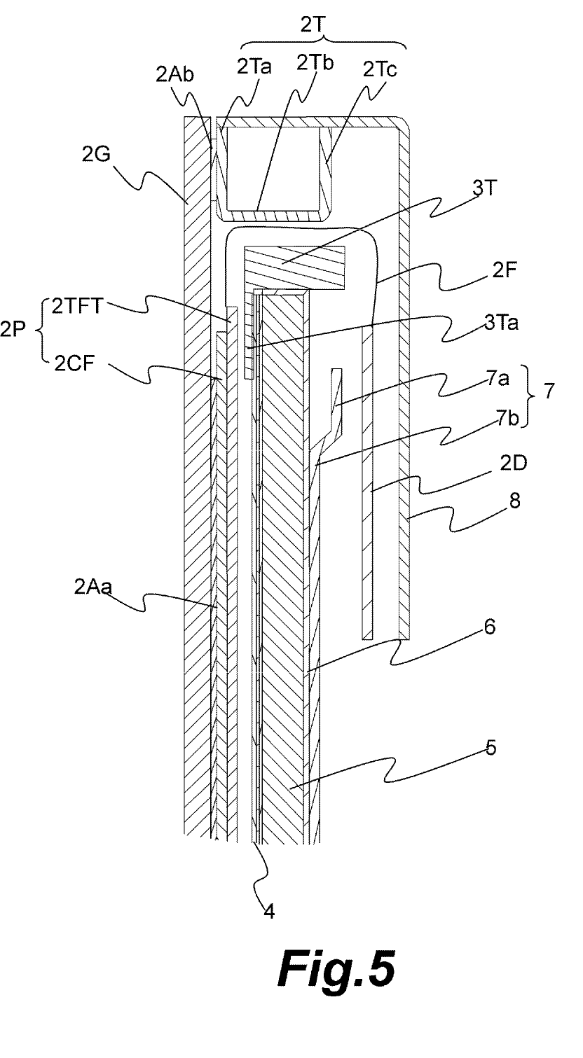

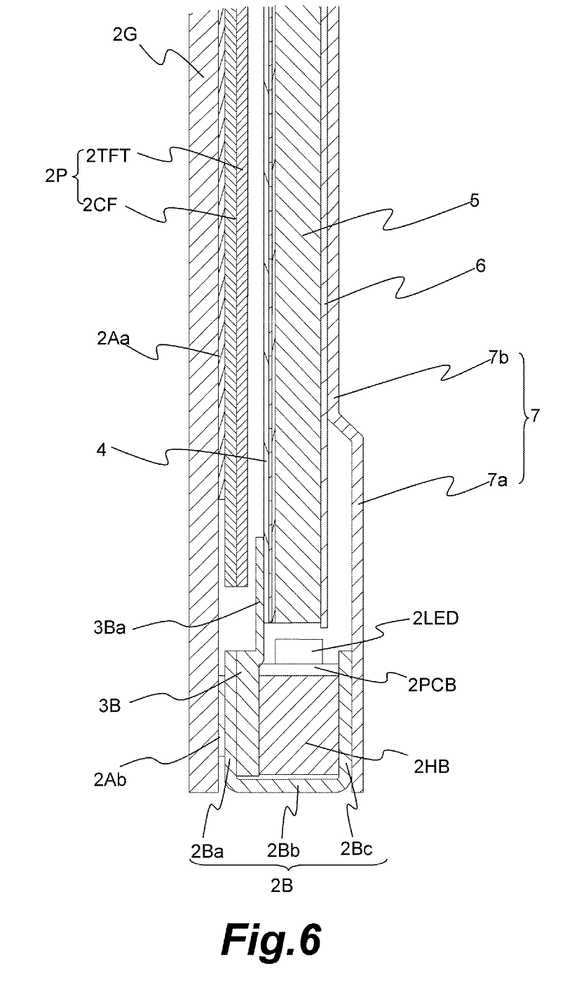

FIG. 3 is an exploded perspective diagram of the display panel unit 2 according to a first embodiment of the present invention. FIG. 4 is an exploded perspective diagram of a frame unit 2FR according to the first embodiment of the present invention. FIG. 5 is a cross-sectional diagram of the upper portion of the display device 1 along section A-A in FIG. 1, and FIG. 6 is a cross-sectional diagram of the lower portion of the display device 1 along section B-B in FIG. 1. The configurations of the respective units of the display device 1 are now described on the basis of these diagrams.

The display panel unit 2 is as shown in FIG. 3, when depicted in exploded view. From the front surface side, a front surface plate 2G, a display panel module 2PM and a frame unit 2FR are disposed.

The front surface plate 2G is made of blue sheet glass or strengthened glass. The front surface plate 2G is fixed to the display panel module 2PM which is disposed on the rear surface side thereof. In the present embodiment, the front surface plate 2G is bonded to the display panel module 2PM by the transparent adhesive 2Aa shown in FIG. 5, for example. The front surface plate 2G is larger than the display panel module 2PM, and the peripheral edge portion of the front surface plate 2G is a region that is not bonded to the display surface of the display panel module 2PM. The transparent adhesive 2Aa is an ultraviolet-curable resin which adheres tightly to the surface of the display panel module 2PM. By means of the transparent adhesive 2Aa, the front surface plate 2G is fixed to the display surface of the display panel module 2PM. The transparent adhesive 2Aa has optical properties close to those of glass in that it is colorless, transparent and has a refractive index of around 1.5, so as not to affect the image display quality.

The display panel module 2PM is configured by a display panel 2P, an electric cable 2F and a drive substrate 2D. In the first embodiment, the display panel 2P is a liquid crystal panel. However, the panel is not limited to being a liquid crystal panel, provided that the panel is a transmissive display panel which displays an image by adjusting the transmissivity of light from the light source. As shown in FIG. 5, the display panel 2P comprises a front surface-side color filter substrate 2CF and a rear surface-side TFT substrate 2TFT. The color filter substrate 2CF is configured by bonding an upper polarization plate (not illustrated) to the front surface (viewing side) of a glass substrate having a color filter formed on one surface thereof. The TFT substrate 2TFT is configured by bonding a lower polarization plate (not illustrated) to the rear surface (the side opposite to the viewing side) of a glass substrate having electrical wiring formed on one surface thereof. The display panel 2P has a structure in which the two substrates are placing facing each other, liquid crystals are sealed in between the two substrates, the periphery thereof is sealed, and an electric cable 2F, which is described below, is connected to the terminal portions of the glass substrates.

The electric cable 2F is a flexible printed circuit (FPC) that electrically connects the terminal portion of the display panel 2P and the drive substrate 2D described below, and an integrated circuit (IC) is mounted near the center thereof.

The drive substrate 2D is an electric circuit which supplies image signals and power to the display panel 2P, and is configured by wiring and elements.

The frame unit 2FR is formed by processing a metal plate, typically a steel plate, etc., in a pressing process, or the like. The frame unit 2FR has a frame shape overall, and is configured by four independent edges: a top edge 2T, a left edge 2L, a right edge 2R and a bottom edge 2B. The frame unit 2FR accommodates a light source, which is described below. The frame unit 2FR has a first surface which is substantially parallel to the front surface plate 2G and opposes the rear surface side of the peripheral edge portion of the front surface plate 2G which is not bonded to the display panel module 2PM, and the front surface plate 2G is bonded to the first surface of the frame unit 2FR by a double-sided tape 2Ab. By this means, the frame unit 2FR holds the front surface plate 2G. The details are described below.

FIG. 4 shows an exploded view of the lower edge 2B of the frame unit 2FR, as a typical example. The edges of the frame unit 2FR each have a substantially U-shaped cross-section in the plane perpendicular to the edge, and a light source substrate 2PCB, on which a light source 2LED is mounted, and a heat sink 2HB are arranged in the space between the two opposing surfaces of the U-shape. The light source 2LED is a light-emitting diode (called “LED” or “light emitting diode” below), and a plurality of LEDs is mounted in a line shape on the light source substrate 2PCB. The light source 2LED generates heat upon emitting light. Since the heat sink 2HB is disposed so as to make tight contact with the light source substrate 2PCB, it is possible to disperse the heat generated by the light source 2LED, efficiently, and decline in the light generation efficiency is suppressed. The light source 2LED, which is a light-emitting member, may comprise white LEDs, or RGB LEDs in which red, green and blue colors are separated in order to enhance the display color gamut. Furthermore, the light-emitting member is not limited to being an LED and may also use a cold cathode fluorescent lamp (CCFL).

The path of the light is now described with reference to FIG. 6. The light emitted from the light source 2LED is input from an end of the light guide plate 5, and is reflected by the reflection sheet 6 disposed on the rear surface of the light guide plate 5. The optical sheet 4 raises the brightness of the light reflected by the reflection sheet 6, scatters the light and inputs the light to the display panel 2P. The light input to the display panel 2P is transmitted through the liquid crystals, exits from the front surface of the transparent adhesive 2Aa and the front surface plate 2G, and can be viewed as an image. The frame unit 2FR, panel holder 3, optical sheet 4, light guide plate 5, reflection sheet 6 and chassis 7 form a plane-shaped light source, and constitute a backlight (surface light source device) which shines light onto the display panel unit 2.

The chassis 7 is made from steel plate, or the like, of which substantially the center portion is formed in a recess shape by squeezing, and includes a peripheral edge section 7a and a bottom section 7b. The bottom section 7b presses the reflection sheet 6, thereby holding the reflection sheet 6 from the rear surface side.

The case 8 is disposed so as to cover the drive substrate 2D of the display panel module 2PM. The case 8 is fixed to the chassis 7 by screws (not illustrated). The case 8 is also formed from a steel plate, etc., by pressing, or the like. The case 8 disperses heat from the drive substrate 2D. Furthermore, the case 8 has a shielding effect which suppresses unwanted radiation from the drive substrate 2D.

The holding structure of the front surface plate 2G is described now with reference to FIG. 5 and FIG. 6. The top edge 2T and bottom edge 2B of the frame unit 2FR have a substantially U-shaped cross-sectional shape in the plane perpendicular to the edge. The top edge 2T is configured by a first surface 2Ta, a second surface 2Tb and a third surface 2Tc. The bottom edge 2B is configured by a first surface 2Ba, a second surface 2Bb and a third surface 2Bc. The second surface extends perpendicularly from the first surface to the rear surface side. The front surface plate 2G is bonded to the frame unit 2FR by the double-sided tape 2Ab which is bonded to the first surface 2Ta of the top edge 2T and the first surface 2Ba of the bottom edge 2B. The second surface extends from the lower end portion of the first surface, in the top edge 2T and the bottom edge 2B. Consequently, in the top edge 2T, the second surface 2Tb is positioned on the backlight side, and in the bottom edge 2B, the second surface 2Bb is positioned on the opposite side from the backlight. The electric cable 2F which is connected to the display panel module 2PM is disposed on the lower side of the top edge 2T, and the second surface 2Tb opposes the electric cable 2F. Consequently, even if the top edge 2T contacts the electric cable 2F, since this involves surface contact by the second surface 2Tb, then the electric cable 2F is not liable to be damaged, compared to when contacted linearly by the end portions of the first surface 2Ta and the third surface 2Tc. Furthermore, there are cases where the IC is mounted at an intermediate point of the electric cable 2F, but by disposing a heat conduction sheet (not illustrated) on the second surface 2Tb, it is possible to promote the dispersion of heat.

On the other hand, in the bottom edge 2B, the end portions of the first surface 2Ba and the third surface 2Bc face towards the backlight, and a space which faces towards the backlight is formed in which the second surface 2Bb is a bottom surface, and the first surface 2Ba and the third surface 2Bc are wall surfaces. In the display device 1 according to the first embodiment, this shape is used to dispose the panel holder 3B, the light source substrate 2PCB and the heat sink 2HB on the inside of the U-shape. Therefore, the light source 2LED is mounted so as to face towards the backlight, and constitutes an edge light type of backlight.

According to the first embodiment, rather than the front surface plate 2G being installed on the chassis, or the like, using separate members, a configuration is adopted in which the front surface plate 2G is bonded directly to the frame unit 2FR which includes the light source. Therefore, it is possible to make the size of the front surface plate substantially the same as that of the frame unit 2FR (the size of the backlight unit), and the frame width can be reduced.

Furthermore, in the configuration of the first embodiment, it is possible to adopt a simple structure in which the light source is fixed directly to the frame unit which is bonded to the front surface plate. Consequently, the cumulative error from the display panel to the light source can be reduced.

### Second Embodiment

Below, a second embodiment of the present invention is described.

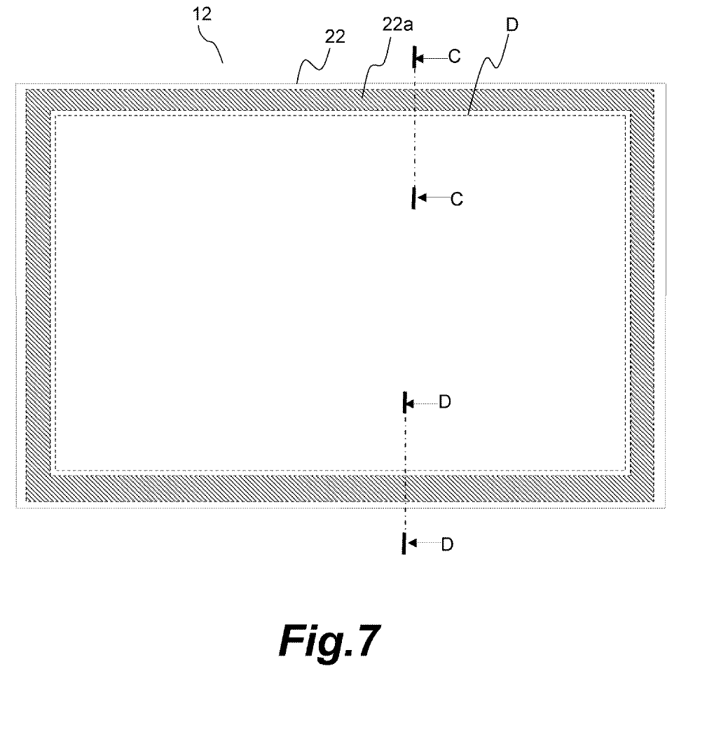

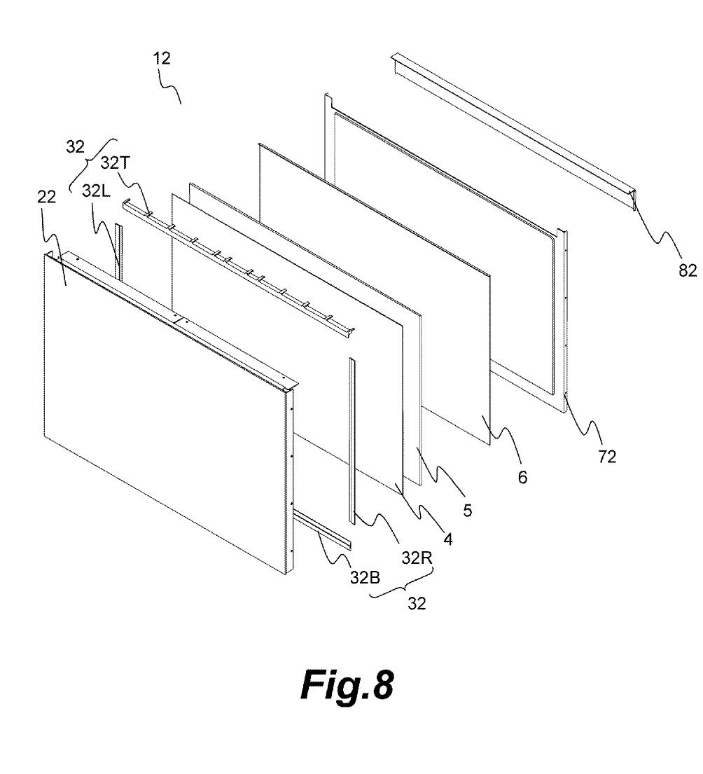

FIG. 7 is front surface diagram of a display device according to a second embodiment of the present invention. Furthermore, FIG. 8 is an exploded perspective diagram of a display device according to the second embodiment of the present invention.

Similarly to the first embodiment, in the display device 12, a display panel unit 22 is situated on the front surface, and a light shielding printed region 22a is disposed in the peripheral edge portion of the rear surface thereof. Furthermore, an image display region D is formed in substantially the center portion thereof.

As illustrated in the exploded perspective view in FIG. 8, a panel holder 32 is disposed on the rear surface side of the display panel unit 22. The panel holder 32 is configured by four edges: a top edge 32T, a left edge 32L, a right edge 32R and a bottom edge 32B. Similarly to the first embodiment, an optical sheet 4, a light guide plate 5 and a reflection sheet 6 are disposed on the rear surface side of the panel holder 32. A chassis 72 is disposed so as to press the reflection sheet 6 from the rear surface side, and a case 82 is fixed to the upper portion thereof.

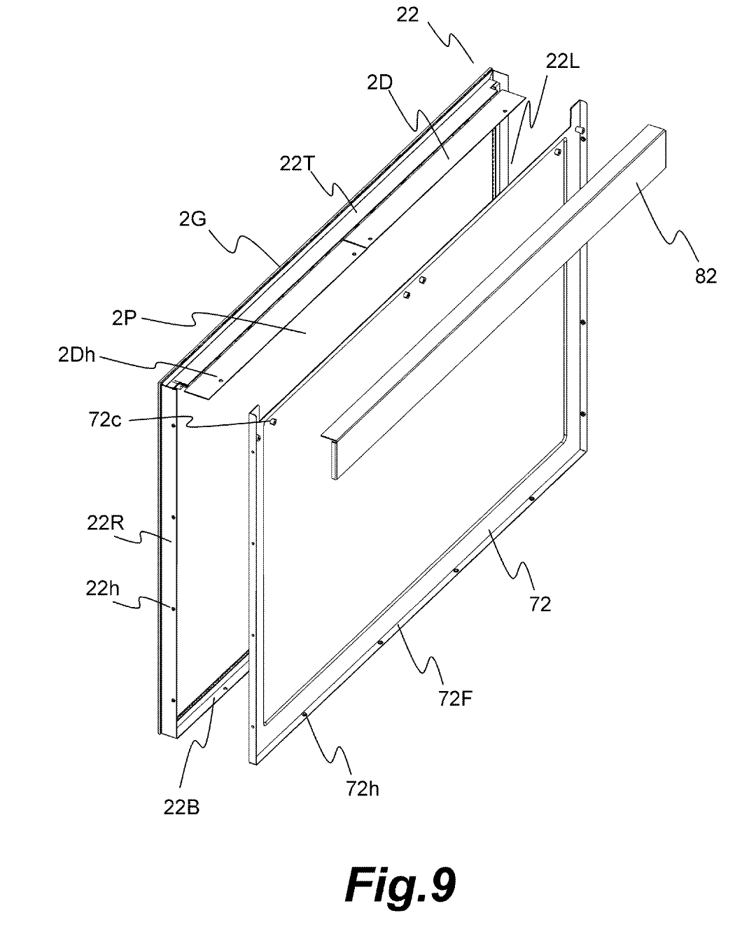

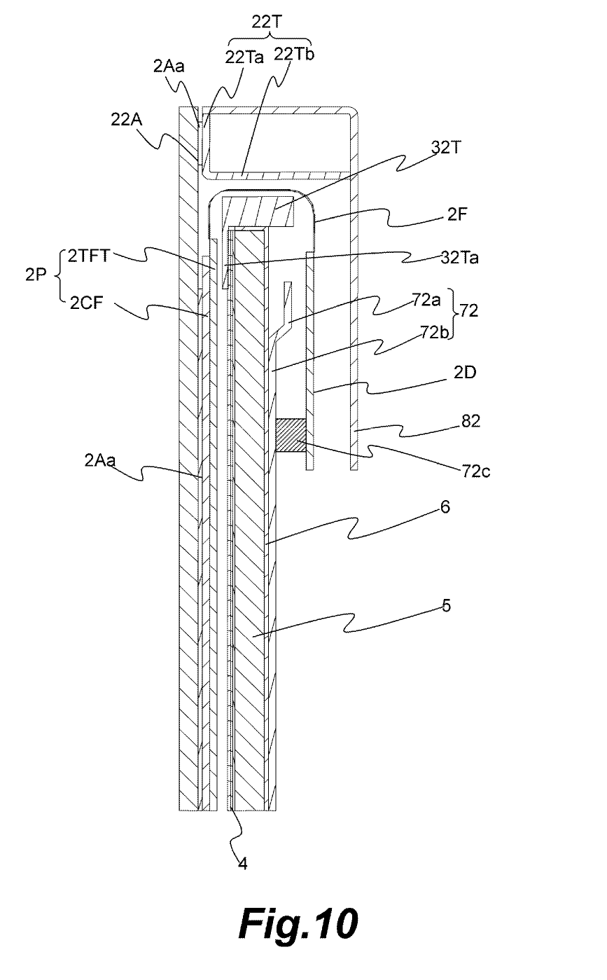

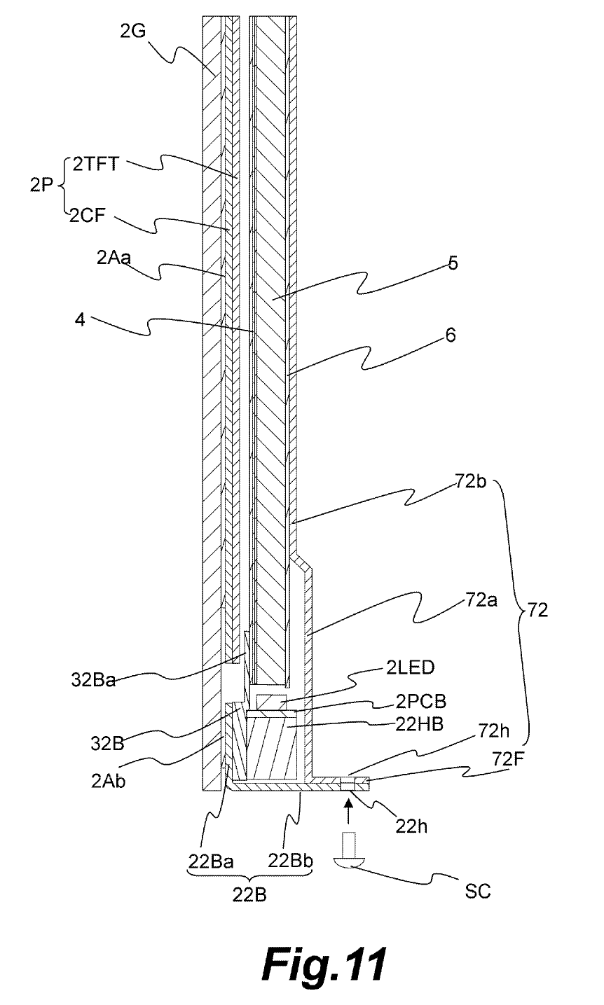

FIG. 9 is an exploded perspective diagram of the display panel unit 22 and the chassis 72 of the display device 12. FIG. 10 is a cross-sectional diagram along section C-C in FIG. 7. FIG. 11 is a cross-sectional diagram along section D-D in FIG. 7.

In FIG. 9 and FIG. 10, the display panel unit 22 is configured by a display panel 2P which is bonded to a front surface plate 2G by transparent adhesive 2Aa, an electric cable 2F which is connected to the display panel 2P, and a drive substrate 2D. Furthermore, the four edges of the frame, namely, the top edge 22T, the left edge 22L, the right edge 22R and the bottom edge 22B, are fixed by double-sided tape 2Ab to the rear surface side of the peripheral edge portion of the front surface plate 2G.

Holes 2Dh which are provided in the drive substrate 2D oppose bosses 72c which are provided in the chassis 72 when in an assembled state. The drive substrate 2D is fixed to the chassis 72 by fixing the holes 2Dh and the bosses 72c by screws (not illustrated).

A flange section 72F which is curved in the rear surface direction is formed in the peripheral edge portion of the chassis 72. Furthermore, a plurality of holes 72h is provided in the flange section 72F.

On the other hand, in each edge of the frame, for instance, in the bottom edge 22B, there is a first surface 22Ba which is a surface that is substantially parallel to the front surface plate 2G, and a second surface 22Bb perpendicular to the first surface 22Ba, and holes 22h are provided in the second surface 22Bb.

The holes 22h in the edges of the frame and the holes 72h in the chassis 72 are located at the same positions when in an assembled state, and the holes 72h in the chassis 72 are tapped so as to engage with screws. As shown in FIG. 11, the chassis 72 is fixed to the second surface 22Bb of the frame by using screws SC.

In FIG. 10, to describe the configuration of the frame, the top edge 22T of the frame has a first surface 22Ta which is substantially parallel to the front surface plate 2G. Furthermore, the top edge 22T has a second surface 22Tb which is a surface perpendicular to the first surface 22Ta that bends and extends from the rear surface side of the first surface 22Ta. The front surface plate 2G is bonded to the first surface 22Ta by double-sided tape 2Aa. The second surface 22Tb opposes an electric cable 2F which is connected to the display panel 2P. Similarly to the first embodiment, the second surface 22Tb makes surface contact with the electric cable 2F and therefore is not liable to damage the electric cable 2F. Furthermore, the second surface 22Tb can promote the dispersion of heat from the electric cable 2F.

As indicated above, in the first embodiment, the cross-sectional shape of the frame is a substantially U-shape, but the cross-sectional shape is not limited to being a U-shape and may also be substantially L-shaped, as in the second embodiment.

### Third Embodiment

Below, a third embodiment of the present invention is described.

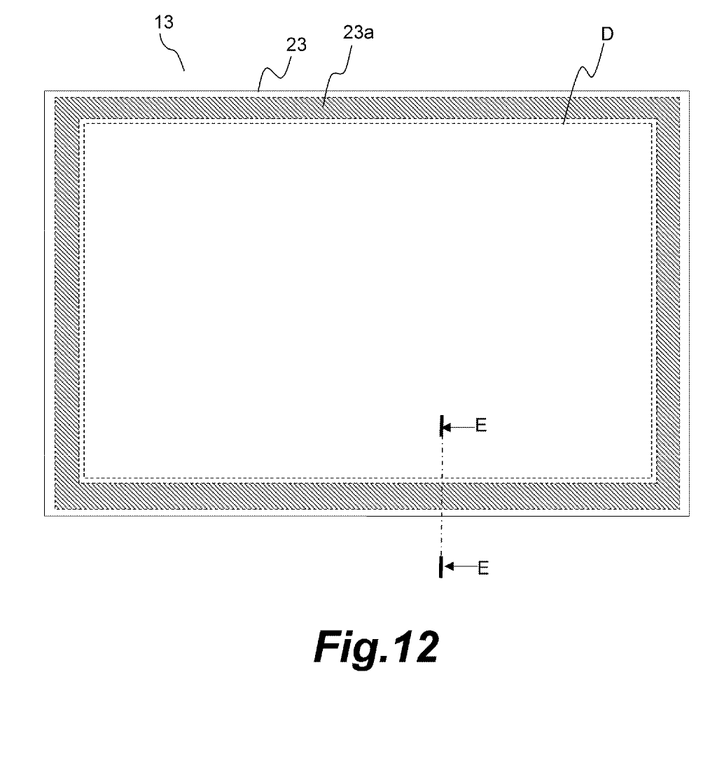

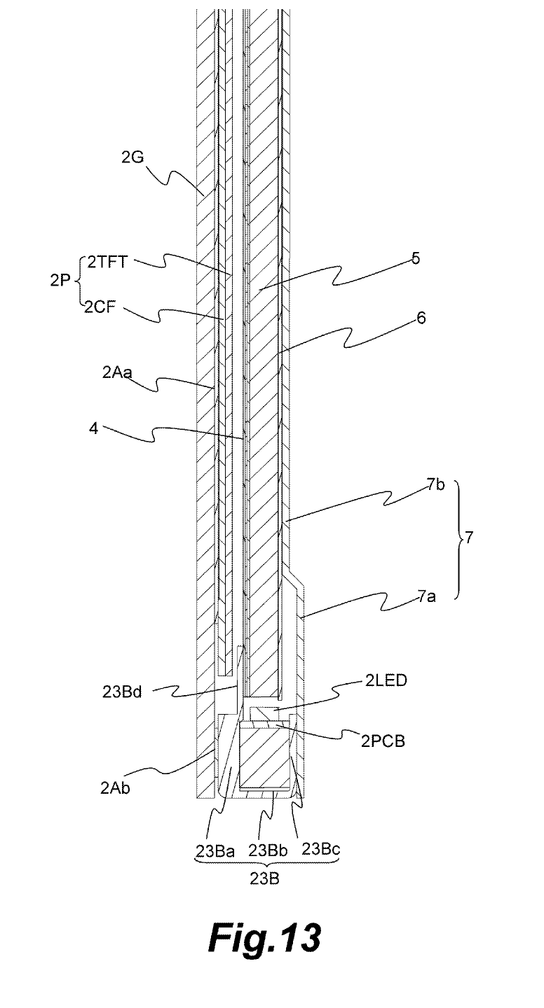

FIG. 12 is front surface diagram of a display device according to a third embodiment of the present invention. FIG. 13 is a cross-sectional diagram along section E-E in FIG. 12.

Similarly to the first embodiment, in the display device 13, a display panel unit 23 is situated on the front surface, and a light shielding printed region 23a is disposed in the peripheral edge portion of the rear surface thereof. Furthermore, an image display region D is formed in substantially the center portion thereof.

The third embodiment has a structure in which the panel holder 3 according to the first embodiment is omitted, and the functions thereof are provided by the frame. In the first embodiment, as shown in FIG. 6, the projecting section 3Ba of the bottom edge 3B of the frame-shaped panel holder 3 is substantially parallel to the display panel 2P, and is disposed between the display panel 2P and the optical sheet 4 and presses the optical sheet 4 from the front surface side. Consequently, the panel holder 3 holds the backlight component members of the optical sheet 4, and the like. In FIG. 13 of the third embodiment, a portion of the bottom edge 23B of the frame projects to the side of the display panel 2P, and forms a projecting section 23Bd. The bottom edge 23B of the frame has a first surface 23Ba that is substantially parallel to the display panel 2P, a second surface 23Bb that is perpendicular to the first surface 23Ba and extends to the rear surface side from the lower end portion of the first surface 23Ba, and a third surface 23Bc that is perpendicular to the second surface 23Bb and opposes the first surface 23Ba. The projecting section 23Bd is a surface that is substantially parallel to the display panel 2P and extends from the end of the first surface 23Ba on the side opposite to the end where the second surface 23Bb extends. The projecting section 23Bd has the function of the panel holder 3 of the first embodiment in pressing the optical sheet 4, similarly to the projecting section 3Ba of the panel holder 3 according to the first embodiment.

A case is envisaged where the lower edge 2B of the frame in FIG. 6 is formed by pressing of a steel plate, or the like, but the bottom edge 23B of the frame in FIG. 13 may be formed by extrusion of aluminum, or the like.

According to the third embodiment, the frame which accommodates the light source and the panel holder which holds the light guide plate, the optical sheet and the reflection sheet, from the front surface side, are configured as a unified body. Accordingly, the structure of the front surface plate 2G and the display panel 2P on the front surface side, and the backlight where the light source 2LED is disposed, on the rear surface side, is further simplified, and cumulative error caused by assembly can be suppressed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-169478, filed on Aug. 22, 2014, which is hereby incorporated by reference herein in its entirety.

What is claimed is:

1. A display device, comprising:
a display panel;
a front surface plate fixed to a display surface of the display panel;
a light source disposed on a rear surface side of the display panel; and
a frame accommodating the light source, wherein
the front surface plate is larger than the display panel,
the frame has a first surface which opposes, from the rear surface side, a peripheral edge portion of the front surface plate that is not fixed to the display surface of the display panel; and
the front surface plate is fixed to the first surface of the frame.

2. The display device according to claim 1, wherein
the light source includes a light-emitting member, alight guide plate that is substantially parallel to the display panel, an optical sheet, and a reflection sheet; and
the light-emitting member is provided on a lower edge of the frame.

3. The display device according to claim 2, wherein
the frame has a second surface extending perpendicularly to the rear surface side from the first surface; and
the light-emitting member is provided on the second surface.

4. The display device according to claim 3, wherein, at an upper edge and a lower edge of the frame, the second surface extends from a lower end portion of the first surface.

5. The display device according to claim 3, wherein a chassis which holds the light guide plate, the optical sheet and the reflection sheet, from the rear surface side, is fixed to the second surface of the frame.

6. The display device according to claim 3, wherein the frame has a third surface which extends perpendicularly from the second surface, the first surface and the third surface are substantially parallel, and the cross-section of each edge of the frame, in a plane perpendicular to the edge, is a U-shape.

7. The display device according to claim 6, wherein the light-emitting member is provided in a space between the first surface and the third surface on a lower edge of the frame.

8. The display device according to claim 6, wherein a chassis which holds the light guide plate, the optical sheet and the reflection sheet, from the rear surface side, is fixed to the third surface.

9. The display device according to claim 1, further provided with a frame-shaped panel holder which is disposed between the display panel and the light source and which holds the light source from the front surface side.

10. The display device according to claim 9, wherein the panel holder is configured as a unified body with the frame.

11. The display device according to claim 10,
wherein the frame has a second surface extending perpendicularly to the rear surface side from the first surface; and
the panel holder has a surface substantially parallel to the display panel, which extends from the opposite end portion of the first surface of the frame to the end portion from which the second surface extends.

12. The display device according to claim 1, wherein the display panel is a liquid crystal panel.
